(19) United States
(12) Patent Application Publication
(10) Pub. No.: US 2014/0224941 A1
(43) Pub. Date: Aug. 14, 2014

(54) LINE GUIDE FOR WORKING VEHICLE IMPLEMENT

(71) Applicant: Deere & Company, Moline, IL (US)

(72) Inventors: Richard J. Gitter, Peosta, IA (US); Ashley T. Anderson, Scales Mound, IL (US); Benjamin L. Krapfl, Dubuque, IA (US)

(73) Assignee: Deere & Company, Moline, IL (US)

(21) Appl. No.: 13/767,765

(22) Filed: Feb. 14, 2013

(51) Int. Cl. F16L 3/01; E02F 9/00

(52) U.S. Cl. CPC F16L 3/01; E02F 9/00
USPC 248/68.1

(57) ABSTRACT

A line guide assembly constrains the movement of working lines, such as hydraulic, pneumatic and electrical lines, that connect an implement attachment, such as a mulching head, to the main power and controls of a working vehicle, such as a skid steer loader. In one form, the line guide assembly has a mounting bracket for connecting to the mounting ear of the implement. An extension arm is coupled to the mounting bracket to accommodate articulation or other movement of the implement. A guide is connected to the extension arm, directly or via an additional cross-member. In one form, the guide defines a catch or loop that receives the working lines running to the implement. As the implement moves the extension arm pivots and the guide engages the working lines, which move through the guide opening, to constrain the working lines to a desired area between the loader and the implement.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to work vehicles, and in particular to work vehicles having powered implements attached thereto.

### BACKGROUND OF THE DISCLOSURE

Work vehicles such as front-end loaders are well known. Front-end loaders can have a drivetrain that includes either wheels or endless tracks. It is conventional to refer to compact wheeled loaders as “skid steer loaders” because to change direction the wheels at either the left or right side of the loader are braked, such that they do not turn over, but rather skid, as the loader turns. Compact loaders with tracks instead of wheels are commonly referred to as either skid steer loaders or “compact track loaders.” For simplicity, the terms “loader” and “skid steer loader” will be used herein to refer to both types of loaders.

Skid steer loaders also typically have left and right interconnected booms or lift arms pivotally connected to the rear tower of the body. The forward ends of the lift arms support an implement attachment, such as a bucket for example. Hydraulic lift actuators are connected between the body and the lift arms to raise and lower the implement attachment. Typically, one or more hydraulic actuators are connected between the lift arms and the implement attachment to articulate the implement attachment with respect to the lift arms.

Skid-steer loaders are versatile vehicles in that they can be used in varied applications by simply changing the implement attached to the lift arms. One such varied application is clearing brush and forestation with a mulching head attachment. Mulching heads, such as manufactured by Fecon, Inc. for example, are designed to mount to existing lift arms and couple to the hydraulic actuators using the hydraulic plumbing lines of the vehicle.

A common problem with implement attachments, especially mulching head attachments, is poor routing of the working lines extending from the vehicle to the implement attachment. The working lines are typically a bundle of several, large-diameter hydraulic plumbing lines and hoses that are necessarily lengthy to accommodate raising and lowering of the lift arms and articulation of the implement during operation. The line bundle can physically interfere with the operator's ingress and egress to the cabin and present a trip hazard for the operator. The individual hoses are also subjected to being damaged or disconnected if caught on trees, brush or other hazards ordinarily present at work sites. In extreme cases, the hoses can fall to the outside of the vehicle and drag on the ground or be caught in the track or under the wheels of the vehicle.

This disclosure addresses the aforementioned problems.

### SUMMARY OF THE DISCLOSURE

A line guide assembly is disclosed for constraining to a desired area or zone working lines, such as hydraulic, pneumatic and electrical lines, that connect an implement attachment, such as an articulating mulching head, to the main power and controls of a working vehicle, such as a skid steer loader.

In one aspect, the line guide assembly can include a mounting bracket for connecting to a mounting location of the implement attachment, an extension arm coupled to the mounting bracket, and a guide coupled to the extension arm to engage the working lines running to the implement attachment and constrain them to the desired area or path of movement.

In another aspect, the line guide assembly can pivot with respect to the implement attachment. For example, the mounting bracket can provide a pivot location for one end of the extension arm such that it can pivot on the mounting bracket. Thus, as the implement attachment is articulated the extension arm can pivot about the pivot location of the mounting bracket and the working lines can move through the guide opening to constrain their movement.

In another aspect, the guide, at least in part, can define a bounded opening that receives the working lines running to the implement attachment. For example, the guide can have a U-shaped tubular body. The ends of the U-shaped guide can be coupled to the extension arm directly or via a cross-member such that the guide opening extends perpendicularly to one side of the extension arm. The guide thus can constrain the working lines to move along a path substantially parallel to the plane of motion of the extension arm, which can be mounted such that its plane of motion is substantially orthogonal to an articulation axis of the implement attachment.

The line guide assembly can include other features. For example, the mounting bracket can also be adapted to connect to an upstanding tab or ear of the implement attachment. The mounting bracket can have first and second plates spaced apart on each side of the mounting ear of the implement attachment. A connector, such as a connector pin, can interlock the plates to the mounting ear. The mounting bracket can also include a clamp arrangement for applying a clamping force from the plates to the mounting ear. The clamping arrangement can have one or more threaded fasteners disposed through openings in the plates for effecting the clamping force.

Still other features of the line guide assembly will be apparent from the following description and accompanying drawings.

### BRIEF DESCRIPTION OF THE DRAWINGS

FIG. 1 is a perspective view showing a work vehicle in the form of a compact loader having an implement attachment to which is mounted a line guide assembly according to the this disclosure;

FIG. 2 is a partial enlarged perspective view thereof showing the line guide assembly in a retracted position such as when the implement attachment is articulated back toward the loader;

FIG. 3 is similar to FIG. 2 although showing the line guide assembly in an extended position such as when the implement attachment is articulated forward away from the loader;

FIG. 4 is a rear elevational view of the line guide assembly;

FIG. 5 is an exploded assembly view of the line guide assembly;

FIG. 6 is a side elevational view of the line guide assembly showing an alternate angular position in dotted lines;

FIG. 7 is a side elevantional view showing counter-rotation of an extension arm about a pivot axis of the line guide assembly with respect to articulation of the implement attachment about an articulation axis; and

FIG. 8 is a view similar to FIG. 7 showing counter-rotation in the opposite direction.

### DETAILED DESCRIPTION

The following describes one or more example constructions of a line guide assembly 10, as shown in the accompanying figures of the drawings described briefly above. Various modifications to the example constructions may be contemplated by one of skill in the art.

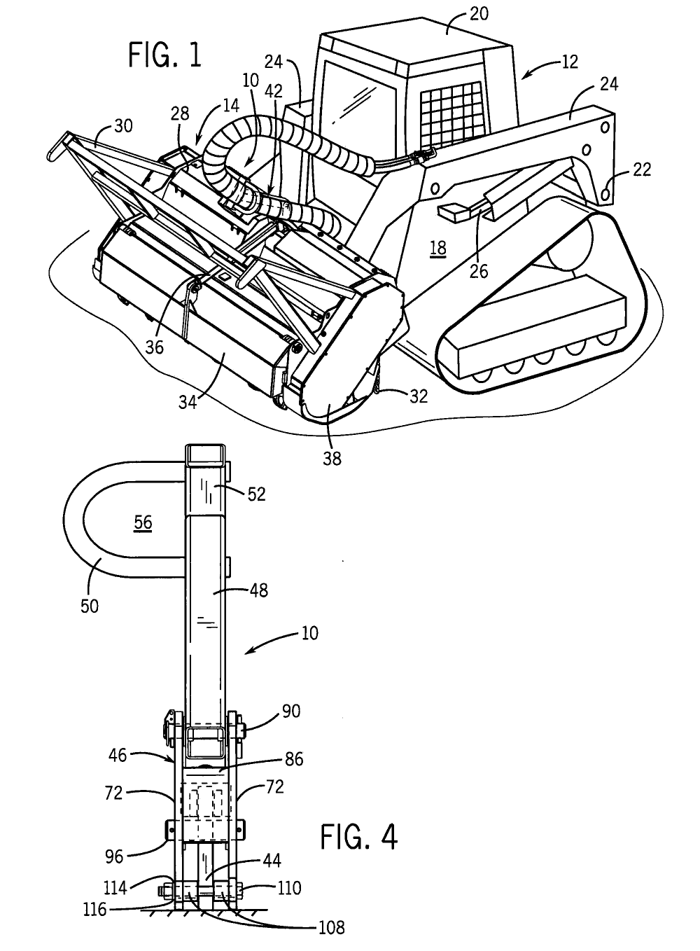

FIG. 1 shows an example application of the line guide assembly 10 incorporated into a working vehicle 12 which powers and controls an implement attachment 14 through a bundle of hydraulic plumbing lines 16. In the example shown in FIG. 1 and described herein, the working vehicle 12 is a compact loader and the implement attachment 14 is a mulching head. The line guide assembly 10 can be used advantageously with existing compact loaders and mulching head attachments, for example the 332D Skid Steer Loader and the 333D Compact Track Loader commercially available from Deere & Co. of Moline, Ill., and the MH60 Mulching Head from Deere & Co., or the Bull Hog (SS) Brush Cutting Attachment, commercially available from Fecon, Inc. of Lebanon, Ohio.

Additionally, while for simplicity a single loader with a mulching head attachment is described herein as an example application for the line guide assembly 10, the line guide assembly 10 can be utilized with various working vehicles and implements. For example, the principles of the line guide assembly 10 disclosed herein can be used with tractors and other agricultural, forestry or construction vehicles, including for example tractors and backhoes, and can be used with any implement attachment, including for example articulating buckets, scrapers, plows, dozers, tree pullers, hammers, breakers and trenchers or other powered implement attachments. As such, the terms “working vehicle” and “implement attachment” are not limited to the loader and mulching head described herein. Further, the term “working lines” can encompass one or more of any type of flexible electrical, pneumatic or hydraulic line or hose used to transfer power or control from the working vehicle to the implement attachment. The term is thus not limited to the hydraulic plumbing line bundle described herein.

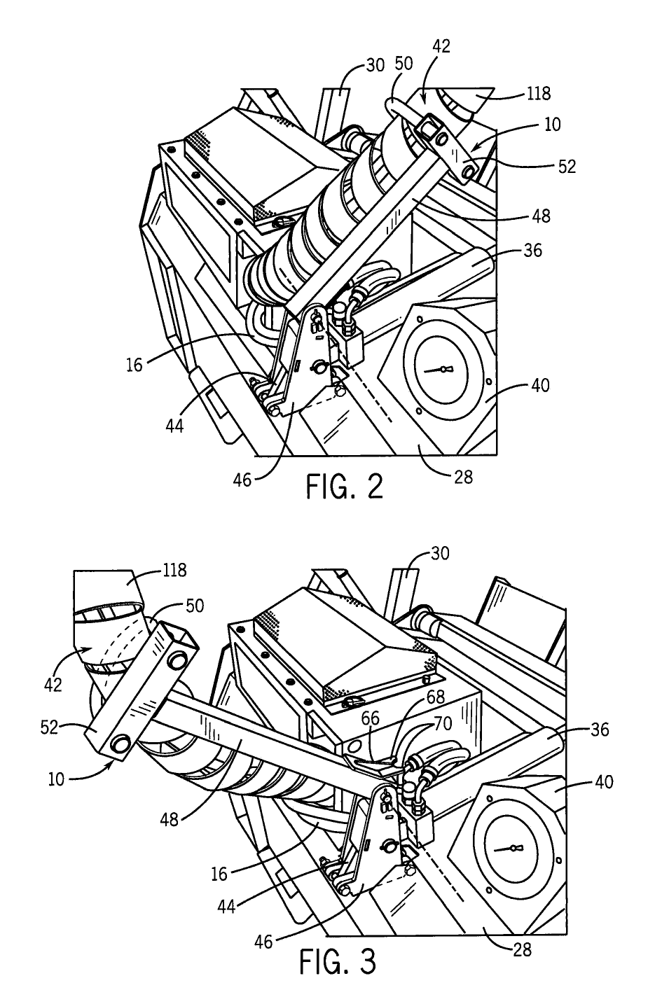

Turning now to the example embodiment, the loader 12 has a body 18, which defines a cabin 20 housing an operator seat and drive and implement controls (not shown). Mounted to pivots 22 at the rear of the loader body 18 are left and right lift arms 24. The lift arms 24 are driven by hydraulic actuators 26 connected to the loader body 18. The mulching head 14 mounts to the free ends of the lift arms 24 in a conventional manner, such as through universal loader mounting brackets (not shown), so that the mulching head 14 can later be removed. The mulching head 14 has a main frame 28 that supports and shrouds the mulching elements (not shown) and provides corresponding brackets (not shown) for coupling with the lift arms 24. Attached to the main frame 28 are other conventional components, including a push over bar 30, a rear chain curtain 32, a door panel 34 and actuating cylinder 36, a hydraulic drive mechanism 38, a pressure gauge 40 (see FIGS. 2 and 3), and a 42 bundle of hydraulic plumbing lines 16, which commonly include supply, return and drain lines. The main frame 28 of the mulching head 14 also includes a mounting location in the form of an upstanding plate-like ear 44, which is welded to, and extends upwardly from, the top wall of the main frame 28.

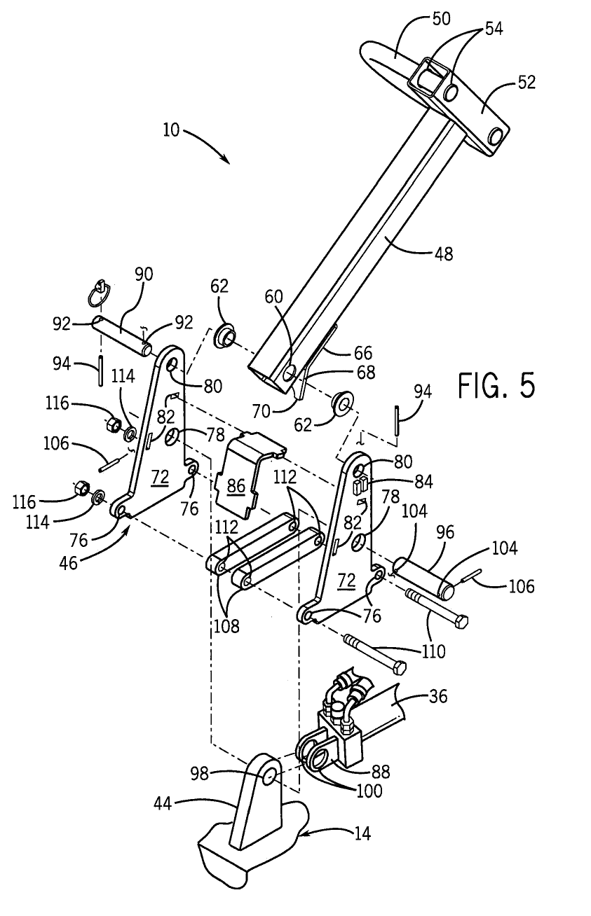

The details of the example construction of the line guide assembly 10 will be now be described with reference to FIGS. 4 and 5. The example line guide assembly 10 includes as main components a mounting bracket 46, an extension arm 48 and a guide 50. The guide 50 is a piece that functions to engage with the line bundle 42 to constrain its position and movement. The guide 50 can be of any suitable construction to perform this function, including any straight, angled or curved solid or tubular structure in an open or closed configuration, including for example a catch bar, hook or loop. In the example shown in the drawings, the guide 50 is formed of round tube stock into a U-shape with an appropriate radius to accommodate the diameter of the line bundle 42. The straight ends of the U-shaped guide 50 are connected to a cross-member 52. The cross-member 52 can be an integral or contiguous part of the extension arm 48, or it can be a separate piece that is connected to the extension arm 48, such as by welding, adhering, press-fitting or other suitable connection technique. In the example construction, the short cross-member 52 is mounted to the end of the long part of the extension arm 48 at a right angle. The cross-member 52 and the extension arm 48 can be any suitable straight, angled, or curved solid or tubular structure, including the square tube construction shown in the example embodiment.

The straight ends of the U-shaped guide 50 fit into sets of paired openings 54 in opposite side walls of the cross-member 52 and are welded or otherwise secured to the cross-member 52. This connection forms a guide opening 56 that is bounded along its entire perimeter by the guide 50 and the cross-member 52 and sized to accommodate the line bundle 42 therein. Additionally, the mounting location provided by the cross-member 52 positions the guide 50, and thereby the guide opening 56, out to one side of the extension arm 48. Specifically, in the example construction, the guide 50 extends out from the cross-member 52 at a right angle such that the guide opening 52 is in a plane that is orthogonal to the long dimension of the extension arm 48, and as will described, can pivot about a pivot axis 58 at the pivot connection of the opposite end of the extension arm 48 to the mounting bracket 46.

Specifically, the pivot axis 58 extends through paired openings 60 through opposite side walls of the extension arm 48 similar to the openings 54 in the side walls of the cross-member 52. The openings 60 can contain bushings 62, such as oil impregnated flanged bushings, to facilitate pivoting. In addition, a gusset 66 can be mounted to this end of the extension arm 48 via welding or other suitable connection. A short, angled end 68 of the gusset 66 can have a round notch that defines a pair of stop tabs 70 used to limit pivoting of the extension arm 48.

The example construction of the mounting bracket 46 has two bracket plates 72 that are formed in an upstanding tapered configuration corresponding to the mounting ear 44 of the mulching head 14. The lower end of each bracket plate 72 has a pair of ears 74 with openings 76 that extend outwardly to the front and back of the plate 72. Each plate 72 also has an opening 78 near the middle of the plate 72, an opening 80 at the upper end, and two rectangular cut-outs 82. Spaced-apart rectangular pieces welded to the outer side of each plate 72 define a pin retainer 84 aligned beneath the center of the upper opening 80. The two plates 72 are joined by an angled spacer 86 with four tabs that fit into the cut-outs 82 and are secured by welding or other suitable technique. The spacer 86 is angled so as not to interfere with the mounting ear 44 of the mulching head 14 when mounting the line guide assembly 10. The spacer 86 is sized to space apart the bracket plates 72 to not only accommodate the width of the mounting ear 44 and the extension arm 48, but also to allow a clevis end 88 of the door actuating cylinder 36 to fit between the bracket plates 72 when assembled to the mulching head 14. The mounting bracket 46 thus forms a yoke or clevis type connection that interlocks with the interconnecting feature, in particular the mounting ear 44 of the mulching head 14, at an interior space between the plates 72.

The upper openings 80 and a pivot pin 90 of the mounting bracket 46 provide the pivot location for the extension arm 48. Specifically, the end of the extension arm 48 fits between the bracket plates 72 so that openings 60 and 80 align and the pivot pin 90 is inserted through these openings along the pivot axis 58. The pivot pin 90 can have transverse openings 92 for a retainer pin 94, such as a cotter pin, roll pin or locking pin, which when inserted in the openings 92 from the outside of the plates 72 are long enough to prevent the pivot pin 90 from loosening and backing out of the openings 80 and possibly disconnecting the extension arm 48 from the mounting bracket 46. The retainer pins 94 can be captured within the slots of the pin retainers 84. The bushings 62 facilitate pivoting of the extension arm 48 on the pivot pin 90.

The mounting bracket 46 also includes a connector pin 96, which can be of a larger diameter than the pivot in 90, that fits through the middle openings 78 of the bracket plates 72 as well as an opening 98 in the mounting ear 44 of the mulching head 14 and openings 100 in the clevis end 88 of the door actuating cylinder 36. Washers 102 can also be mounted to the inside of the bracket plates 72 around the openings 78. Like the pivot pin 90, the connector pin 96 has transverse openings 104 for additional retainer pins 106 that when inserted into the openings 104 from outside the plates 72 prevent the connector pin 96 from backing out from one of the openings 78. Furthermore, the mounting bracket 46 has an additional securing mechanism to securely clamp the bottoms of the bracket plates 72 against the mounting ear 44 of the mulching head 14. Specifically, the mounting bracket 46 includes a pair of elongated adaptors 108 that are sized to occupy the spaces between the inside of the bracket plates 72 and the mounting ear 44. Bolts 110, or other suitable threaded or unthreaded fasteners, fit through openings 112 in the adapters 108 and openings 76 in the lower ears 74 of the bracket plates 72. Washers 114 and nuts 116 fit onto the bolts 110. Tightening the bolts 110 pulls the lower ends of the plates 72 toward each other to clamp the adaptors 108 against the mounting ear 44 of the mulching head 14.

Having described the components of an example line guide assembly construction, an example method of installation will now be described. Installation of the line guide assembly 10 typically begins once the mulching head 14 is mounted to the lift arms 24 of the loader 12. If the mulching head 14 has a movable “trap” door panel 34 covering the rotating elements of the mulching head 14, the clevis end 88 of the door actuating cylinder 36 is positioned to straddle the mounting ear 44. With bolts 110 slightly loosened and the connector pin 96 removed, the mounting bracket 46 is then placed over the mounting ear 44 to straddle it and the clevis end 88 of the cylinder 36. The connector pin 96 is then installed through the openings 78, 100 and 98 in the bracket plates 72, clevis end 88 and mounting ear 44, respectively, to connect both the door actuating cylinder 36 and the mounting bracket 46 to the mulching head 14. Retaining pins 106 then can be inserted through the openings 104 of the connector pin 96. Tightening the bolts 110 clamps the mounting bracket 46 to the mounting ear 44. The line bundle 42 is then fed into the guide opening 56 and the extension arm 48 can be attached to the mounting bracket 46, either before or after the hydraulic plumbing lines 16 are connected to the hydraulic fittings of the mulching head 14. The extension arm 48 can be pivotally mounted to the mounting bracket 46 by placing the proper end between the bracket plates 72 so that the openings 60 align with the openings 80 and then inserting the pivot pin 90 through these openings, and bushings 62, along the pivot axis 58. Retainer pins 94 can then be inserted into openings 92 to retain the pivot pin 90 in place. The lower ends of the retainer pins 94 can be pressed into the gaps in the pin retainers 84.

Once installed, the line guide assembly 10 holds the line bundle 40, or individual lines and hoses, in a desired area, for example in a central forward area of the loader body 18, clear of the operator's access into and out of the cabin 20, and can be kept from extending out to the side of the loader body 18 or dropping to the ground where they can be caught in brush, moving parts of the vehicle, the implement or other objects and damaged or disconnected.

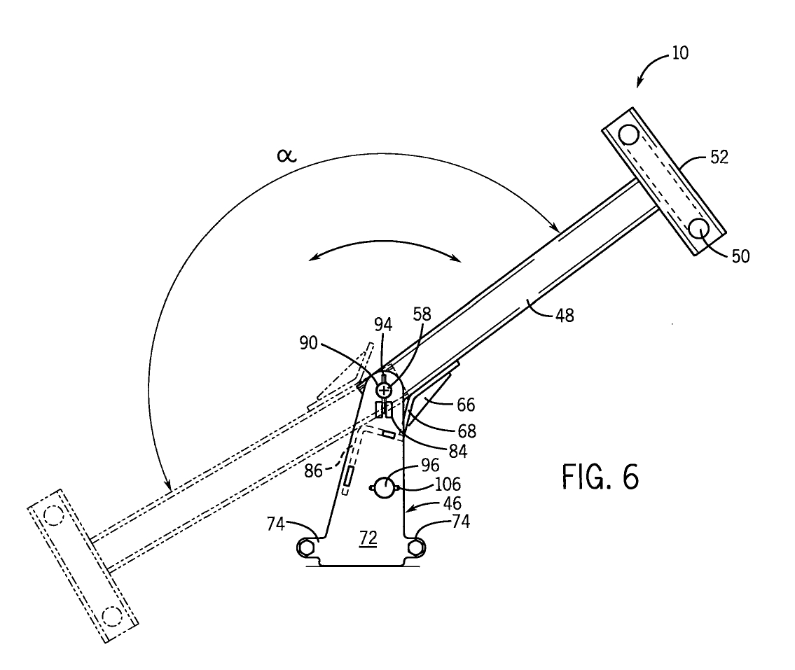

The line guide assembly 10 works to manage the position of the line bundle 42 relative to the loader 12 and the mulching head 14, both when stationary and when one or both of the mulching head 14 and the lift arms 24 are in motion. In other words, the line guide assembly 10 can constrain the static position of the line bundle 42 as well as the dynamic position of the line bundle 42. The line guide assembly can be constructed with the extension arm 48 fixedly mounted to the mounting bracket 46, and thereby the mulching head 14, since the line bundle 42 is free to slide through the guide opening 56. However, the pivoting action of the extension arm 48 allows it to swing through a pivot angle as the lift arms 24 are raised and lowered or as the mulching head 14 is articulated, or when both move concurrently. As shown in FIG. 6, the extension arm 48 can pivot about the pivot axis 58 within the plane of motion greater than 180 degrees. This pivot angle (α) is limited in the clockwise, or forward, direction by the engagement of the stop tabs 70 with the short leg of the spacer 86, and in the opposite direction by engagement of the extension arm 48 with the long leg of the spacer 86.

With the line guide assembly 10 mounted so that the pivot axis 58 is generally parallel to the axis of rotation of the loader drive wheels or track, and thereby generally parallel to the main axis of articulation of the mulching head 14, the extension arm 48 can pivot in a plane that extends in the front to rear direction of the vehicle, that is generally orthogonal to the pivot axis. The line guide assembly 10 can thus guide the line bundle 42 to extend and move generally in the front to back direction alongside the extension arm 48 as it pivots.

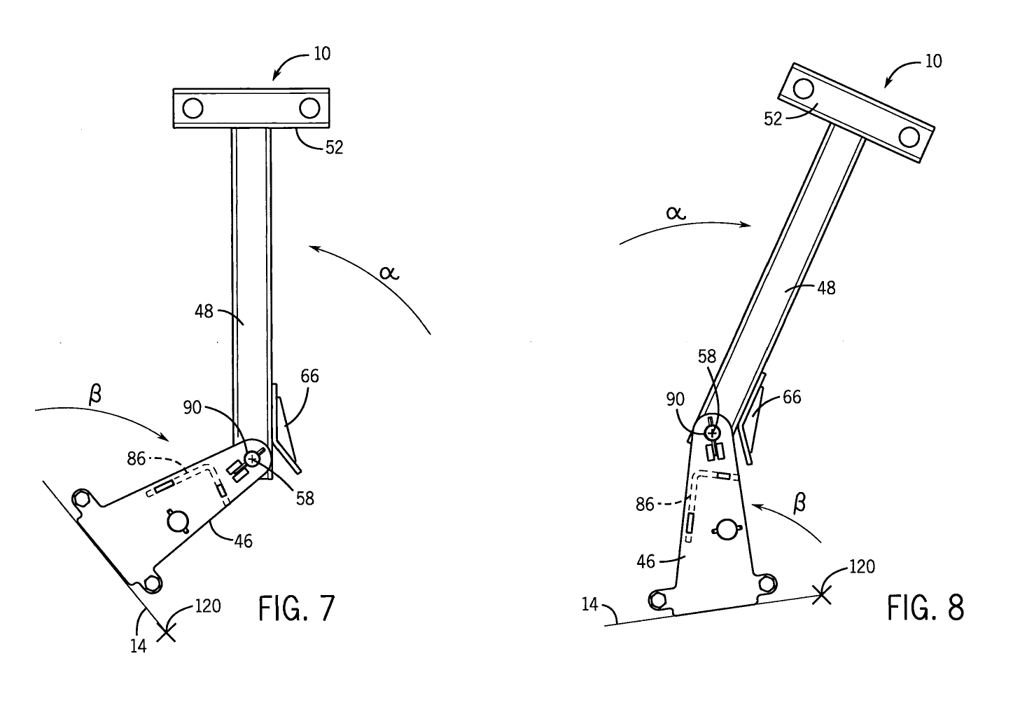

Moreover, the extension arm 48 can pivot in a direction counter to the articulation direction of the mulching head 14. For example, as shown in FIG. 7, as the mulching head 14 is articulated backward through pivot angle (β) (which is clockwise in FIG. 7) about an articulation axis 120, the extension arm 48 can pivot forward through pivot angle (a) about the pivot axis 58 (counterclockwise in FIG. 7). The reverse can occur when the mulching head 14 is articulated backward, as shown in FIG. 8. This counter pivoting of the extension arm 48 helps to feed the line bundle 40 through the guide opening 56, and thereby limit pulling and binding, while the mulching head 14 articulates.

Thus, the extension arm 48 can pivot with respect to the loader 12, the lift arms 34 and the mulching head 14. This relative movement allows the line guide assembly 10 to guide and position the line bundle 42 in a stable, reliable and efficient manner without binding as the lift arms 24 and mulching head 14 move. Bundling the individual lines with spiral wrapping 118 or the like, as shown in FIGS. 2 and 3, also aids in containing the lines and easing sliding through the guide opening 56.

The line guide assembly thus retains the line bundle 42 within the space between the front of the loader 12 and the back of the mulching head 14 as well as between the left and right sides of the loader 12 and mulching head 12. The line guide assembly 10 also keeps the line bundle 42 raised above the ground away from the wheels or tracks of the loader 12 and the moving elements of the mulching head 14, while at the same time preventing the line bundle 42 from interfering with the operator's access to and from the cabin 20.

The foregoing detailed description describes the subject of this disclosure in one or more examples. A skilled person in the art to which the subject matter of this disclosure pertains will recognize many alternatives, modifications and variations to the described example(s). The scope of the invention is thus defined not by the detailed description, but rather by the following claims.

What is claimed is:

1. In a work vehicle having an implement attachment which has a mounting location and one or more working lines operatively coupling the implement attachment to the vehicle, a line guide assembly comprising:
a mounting bracket for connecting to the mounting location of the implement attachment;
an extension arm coupled to the mounting bracket; and
a guide coupled to the extension arm to engage the working lines running to the implement attachment;
wherein the engagement of the guide with the working lines constrains the position of the working lines.

2. The assembly of claim 1, wherein the extension arm is coupled to the mounting bracket to pivot with respect to the mounting bracket about a pivot axis.

3. The assembly of claim 2, further including a cross-member connected to the extension arm, the cross-member extending at an angle to the extension arm to define a mounting location for the guide.

4. The assembly of claim 3, wherein the guide at least in part forms a bounded opening through which the working lines are disposed.

5. The assembly of claim 4, wherein the guide has a U-shaped body the ends of which are coupled to the cross-member such that the guide opening extends perpendicularly to one side of a plane of motion of the extension arm to constrain the working lines to move along a path substantially orthogonal to the pivot axis.

6. The assembly of claim 2, wherein the mounting bracket includes a first plate and a second plate spaced from the first plate, wherein the first and second plates cooperate to form the mounting location for the extension arm.

7. The assembly of claim 6, wherein the extension arm is coupled to the mounting bracket between the first and second plates.

8. The assembly of claim 7, wherein the mounting bracket includes a pivot pin and the first and second plates define openings receiving the pivot pin, and wherein the pivot pin pivotally couples the extension arm to the first and second plates.

9. The assembly of claim 6, wherein the mounting bracket includes a connector adapted to interlock with the mounting location of the implement attachment.

10. The assembly of claim 9, wherein the mounting bracket includes a clamp arrangement for applying a clamping force from the first and second plates to the mounting location of the implement attachment.

11. The assembly of claim 10, wherein the clamping arrangement includes a threaded fastener disposed through openings in the first and second plates.

12. In a work vehicle having an implement arm to which is connected an implement attachment that can articulate with respect to the implement arm and which has a mounting location and one or more working lines operatively coupling the implement attachment to the vehicle, a line guide assembly comprising:
a mounting bracket adapted to connect to the mounting location of the implement attachment and provide a pivot location;
an extension arm coupled to the pivot location of the mounting bracket to be pivotal with respect to the implement attachment; and
a guide having a body that at least in part defines a bounded opening that receives the working lines running to the implement attachment;
wherein as the implement attachment articulates the extension arm pivots about the pivot location and the working lines move through the guide opening.

13. The assembly of claim 12, further including a cross-member connected to the extension arm, the cross-member extending at an angle to the extension arm to define a mounting location for the guide.

14. The assembly of claim 13, wherein the guide has a U-shaped body the ends of which are coupled to the cross-member such that the guide opening extends perpendicularly to one side of a plane of motion of the extension arm.

15. The assembly of claim 12, wherein the mounting bracket includes a first plate and a second plate spaced from the first plate, wherein the extension arm is pivotally connected to the first and second plates by a pivot pin extending through openings in the first and second plates.

16. The assembly of claim 15, wherein the mounting bracket includes a connector adapted to interlock with the mounting location of the implement attachment, and wherein the mounting bracket includes a clamp arrangement for applying a clamping force from the first and second plates to the mounting location of the implement attachment.

17. In a work vehicle having an implement arm to which is connected an implement attachment that can articulate with respect to the implement arm and which has a mounting ear and one or more working lines operatively coupling the implement attachment to the vehicle, a line guide assembly comprising:
a mounting bracket having a plate connected to the mounting ear by a fastener and defining a pivot location;
an extension arm one end of which is coupled to the pivot location of the mounting bracket to be pivotal with respect to the implement attachment;
a cross-member connected to the extension arm to define a mounting location at a right angle to the extension arm; and
a guide coupled to the mounting location of the cross-member to define a bounded opening that receives the working lines running to the implement attachment;
wherein as the implement attachment articulates about the articulation axis the extension arm pivots about the pivot location of the mounting bracket and the guide engages the working lines as the working lines move through the guide opening.

18. The assembly of claim 17, wherein the mounting bracket includes a second plate spaced from the first plate on an opposite side of the mounting ear, and wherein the extension arm is pivotally connected between the first and second plates by a pivot pin extending through openings in the first and second plates.

19. The assembly of claim 17, wherein the mounting bracket includes a connector adapted to interlock with the mounting ear of the implement attachment, and wherein the mounting bracket includes a clamp arrangement for applying a clamping force from the first and second plates to the mounting ear of the implement attachment.

20. The assembly of claim 17, wherein the guide has a U-shaped body the ends of which are coupled to the cross-member such that the guide opening extends perpendicularly to one side of a plane of motion of the extension arm.
